(19) United States
(12) Patent Application Publication
(10) Pub. No.: US 2015/0357653 A1
(43) Pub. Date: Dec. 10, 2015

(54) Vanadium Solid-Salt Battery and Method for Producing Same

(71) Applicants: Brother Kogyo Kabushiki Kaisha, Nagoya-shi (JP); Tohoku Techno Arch Co., Ltd., Sendai-shi (JP)

(72) Inventors: Shigeki Yoshida, Toyoake-shi (JP); Tomoo Yamamura, Sendai-shi (JP)

(21) Appl. No.: 14/828,744

(22) Filed: Aug. 18, 2015

Related U.S. Application Data
(63) Continuation-in-part of application No. PCT/JP2014/053396, filed on Feb. 14, 2014.

(30) Foreign Application Priority Data
Feb. 18, 2013 (JP) 2013-029379

(51) Int. Cl. H01M 4/90; H01M 8/10; H01M 8/18; H01M 8/20; H01M 4/88; H01M 8/02

(52) U.S. Cl. CPC H01M 4/9083; H01M 4/8846; H01M 8/0247; H01M 8/188; H01M 8/20; H01M 8/10; H01M 2220/20

(57) ABSTRACT

A vanadium solid-salt battery having enhanced effective utilization is provided. The vanadium solid-salt battery includes: electrodes containing a carbon electrode material that carries a precipitation containing a vanadium ion or a vanadium-containing cation as an active material; and a separator disposed between the electrodes. At least a part of a surface of the carbon electrode material is coated with the precipitation.

### CROSS-REFERENCE TO RELATED APPLICATION

The present application is a continuation-in-part of International Application PCT/JP2014/053396, filed on Feb. 14, 2014, which claims the benefit of Japanese Patent Application No. 2013-029379, filed on Feb. 18, 2013, each of which is incorporated herein by reference.

### FIELD OF DISCLOSURE

Aspects described herein relate to a vanadium battery using an electrolyte that contains a vanadium ion or a vanadium-containing cation as an active material. Specifically, it relates to a vanadium solid-salt battery (hereinafter, may also be referred to as a “VSSB”) where a solid vanadium compound, which is an electrolyte, is carried in a carbon electrode material.

### BACKGROUND

Secondary batteries are widely used not only for digital appliances but also for electric vehicles and hybrid vehicles using motor power. Among such secondary batteries, redox flow batteries utilizing vanadium as an active material are known. Redox flow batteries carry out charge and discharge by variation of the ion valence utilizing two reduction/oxidation pairs (redox pairs) that produce a reduction/oxidation (redox) reaction.

In particular, fluid circulating redox flow batteries are used in the field of large power storage. The fluid circulating redox flow batteries charge and discharge by supplying a sulfuric acid solution of vanadium retained in a tank to a fluid circulating cell. Vanadium ions in +2 valence and +3 valence oxidation states (V²⁺ and V³⁺) and vanadium ions in +4 valence and +5 valence oxidation states (V⁴⁺ and V⁵⁺) are contained as the redox pairs.

Such fluid circulating redox flow battery is configured with a cathode tank, an anode tank, a cell to carry out charge and discharge, and a pump. The cathode tank stores an electrolyte solution containing an active material on the cathode side. The anode tank stores an electrolyte solution containing an active material on the anode side. The pump supplies an electrolyte solution for each electrode to the cell. The cathode electrolyte solution and the anode electrolyte solution are transferred from the cathode tank and the anode tank to the cell by the pump for circulation. The cell has a structure of sandwiching the ion exchange membrane with the cathode and the anode. A redox flow battery utilizing vanadium as an active material shows the following reactions in the cathode solution and the anode solution.

Cathode: VO²⁺(aq)+H₂O [symbol] VO₂⁺(aq)+e⁻+2H⁺ (1)

Anode: V³⁺(aq)+e⁻ [symbol] V²⁺(aq) (2)

In the formula (1), “ [symbol] ” denotes chemical equilibrium. The index “(aq)” associated with the ions denotes that the ions are present in solutions. In other formulae herein, “ [symbol] ” and “(aq)” also mean the same.

The electrical capacity of a battery is determined by an amount of an active material, for example, vanadium. For example, the electrical capacity of a fluid circulating redox flow battery containing two different electrolyte solutions, a cathode electrolyte solution and an anode electrolyte solution, having a certain molar concentration is directly proportional to the volume of the two electrolyte solutions. In other words, the electrical capacity of a fluid circulating redox flow battery increases when the volume of the electrolyte solutions for the cathode and the anode is increased. The increase in the volume of the electrolyte solutions may be achieved by an increase in the volume of the tanks to hold the electrolyte solutions. In the meanwhile, the increase in the electrical capacity may also be achieved similarly by thickening the concentration of the active material in the electrolyte solutions.

The battery performance is also expressed by energy density apart from the electrical capacity. The energy density is defined by an amount of energy (amount of power) that may be extracted from the battery. As a high energy density secondary battery utilizing a reduction/oxidation reaction, a lithium ion secondary battery is known, for example. One of the reasons why lithium is used in secondary batteries is because it is possible to obtain high energy density.

Fluid circulating redox flow batteries have to circulate an electrolysis solution by a pump. Since such fluid circulating redox flow battery uses an electrolyte solution having a concentration of not precipitating an electrolyte associated with a reduction/oxidation reaction, the energy density generally decreases so that the tank has to be larger to obtain specific electrical capacity. It becomes difficult to obtain a fluid circulating redox flow battery that is lightweight and small in size and has high output performance.

In order to obtain a redox battery that is lightweight and small in size and has high output performance, a stationary redox battery where an electrolysis solution is not circulated is proposed. The stationary redox battery does not have an electrolysis solution retaining tank. A stationary redox battery at least has a separator, electrolyzers on the cathode side and the anode side, a bipolar plate on the cathode side, a bipolar plate on the anode side, a metal plate having a cathode terminal, and a metal plate having an anode terminal. Regarding the bipolar plates, a pair of bipolar plates is configured with the one bipolar plate on the cathode side and the one bipolar plate on the anode side. The stationary redox battery has a configuration where the electrolyzers on the cathode side and the anode side are filled with a mixture of an electrolysis solution containing vanadium ions, which are active materials, and carbon powder or chips, which are conductive materials.

The stationary redox battery does not circulate the electrolysis solution. However, the stationary redox battery still requires the presence of a large amount of electrolysis solution, so that it is difficult to obtain both high output performance having high electrical capacity and high energy density and lighter weight and smaller size. The stationary redox battery of Patent Document 2 also has disadvantages, such as having to deal with fluid leakage and the like.

Also proposed is a VSSB using an electrode where a solid electrolyte containing a vanadium ion or a vanadium-containing cation as an active material is carried in an electrode material, such as carbon fiber.

### BRIEF SUMMARY

The VSSB is very useful in satisfying both requirements of high output performance and light weight and small size. It is desired to improve such VSSB in the battery capacity, that is, effective utilization.

Aspects described herein relate to a VSSB including: electrodes containing a carbon electrode material that carries a precipitation containing a vanadium ion or a vanadium-containing cation as an active material; and a separator disposed between the electrodes, wherein at least a part of a surface of the carbon electrode material is coated with the precipitation.

This summary is not intended to identify critical or essential features of the disclosure, but instead merely summarizes certain features and variations thereof. Other details and features will be described in the sections that follow.

### BRIEF DESCRIPTION OF THE DRAWINGS

Aspects of the disclosure are illustrated by way of example, and not by limitation, in the accompanying figures in which like reference characters may indicate similar elements.

FIG. 1 is a diagram illustrating a schematic configuration of a VSSB.

FIG. 2 is a conceptual diagram of an embodiment of a VSSB.

FIG. 3 illustrate a VSSB of the present disclosure, where (a) is a conceptual diagram illustrating a state in which at least a part of a surface of carbon fiber constituting a carbon electrode material is coated with a precipitation containing a vanadium ion or a vanadium-containing cation as an active material and (b) is a conceptual diagram illustrating an AA cross-sectional view of (a).

FIG. 4 is a photograph by a 200-power optical microscope illustrating a VSSB of the present disclosure and illustrating a state in which at least a part of a surface of carbon fiber constituting a carbon electrode material is coated with a precipitation containing a vanadium ion or a vanadium-containing cation as an active material.

FIG. 5 is a conceptual diagram illustrating a conventional VSSB and illustrating a state in which bulk precipitations containing vanadium ions or vanadium-containing cations as active materials are precipitated on a part of a surface of a carbon electrode material.

FIG. 6 is a photograph by a 200-power optical microscope illustrating a conventional VSSB and illustrating a state in which bulk precipitations containing vanadium ions or vanadium-containing cations as active materials are precipitated on a part of a surface of a carbon electrode material.

FIG. 7 is a conceptual diagram illustrating a VSSB of the present disclosure and illustrating a state in which at least a part of a surface of micropores of activated carbon constituting a carbon electrode material is coated with precipitations containing vanadium ions or vanadium-containing cations as an active material or at least a part of micropores of activated carbon is filled with the precipitations.

FIG. 8 is a conceptual diagram illustrating a cross section of granular activated carbon constituting a carbon electrode material and illustrating a state in which at least a part of a surface of granular activated carbon is coated with precipitations containing vanadium ions or a vanadium-containing cations as an active material or at least a part of micropores of activated carbon is filled with the precipitations.

FIG. 9 illustrates a flow of a method of manufacturing a VSSB.

FIG. 10 is a graph illustrating relationship between the amount of carried precipitations (active material) and the effective utilization in vanadium solid-salt batteries of Examples and vanadium solid-salt batteries of Comparative Examples.

### DETAILED DESCRIPTION

The present disclosure relates to a VSSB including: electrodes containing a carbon electrode material that carries a precipitation containing a vanadium ion or a vanadium-containing cation as an active material; and a separator disposed between the electrodes. The present disclosure relates to a VSSB, wherein at least a part of a surface of the carbon electrode material is coated with the precipitation.

Generally, it is preferred that a battery has electrical capacity close to theoretical capacity by effectively utilizing an electrode active material (in the present disclosure, may also be referred to as an “active material”) involved in an electrochemical reaction. Here, the theoretical capacity of a battery is a total amount of electrochemical equivalents of electrode active materials involved in an electrochemical reaction. The effective utilization of a battery is a ratio of actual electrical capacity where the theoretical capacity of the battery is 100%. It is generally known that the electrical capacity obtained from one battery is much smaller than the theoretical capacity. The electrical capacity of a battery is smaller than the theoretical capacity in such a manner because losses are produced that are caused by various types of polarization (state where the electrode potential shifts from the spontaneous potential) when a current flows. Such losses include (1) activation polarization (activation overvoltage) for the progress of a reaction on a surface of an electrode and (2) concentration polarization (concentration overvoltage) due to a concentration difference in reactants and products produced in an electrochemical reaction as a result of mass transfer. Such polarization phenomenon occurs because a part of energy is consumed in the form of heat loss. Because of the polarization phenomenon, a battery is not capable of converting all theoretically available energy to electrical energy and the actual electrical capacity turns out to be smaller than the theoretical capacity based on the electrode active material.

In order to bring the battery capacity closer to the theoretical capacity, the polarization phenomenon has to be suppressed. In a fluid circulating vanadium redox flow battery, concentration polarization (concentration overvoltage) has to be suppressed that is produced by the difference (diffusion of the active material) between, for example, the concentration of the active material near the surface of the electrode material and the concentration of the active material in an area away from the surface of the electrode material. In the fluid circulating vanadium redox flow battery, modulation of a rate and an amount of flow of the electrolysis solution sent from a tank to a cell, for example, is considered as a way of suppressing the concentration polarization (concentration overvoltage).

In the meanwhile, a VSSB is not in the form of circulating an electrolyte solution, so that a design different from a fluid circulating vanadium redox flow battery is required to bring the battery capacity closer to the theoretical capacity. For example, in the VSSB, an electrolysis solution is not present in a large amount as it is in the vanadium redox flow battery. In the VSSB, the difference in diffusion concentration of an electrolysis solution is not as large as it is in the fluid circulating vanadium redox flow battery. This is because an electrolysis solution and the like to be supplied to a cell are not present in the VSSB.

In the present disclosure, at least a part of a surface of the carbon electrode material is coated with a precipitation containing a vanadium ion or a vanadium-containing cation as an active material. In other words, a precipitation is present near the carbon electrode material. By coating at least a part of a surface of the carbon electrode material with the precipitation, it is possible to suppress the activation polarization (activation overvoltage) which is involved in a reaction (charge transfer reaction) occurring on the surface of the carbon electrode material. In the VSSB of the present disclosure, by coating at least a part of a surface of the carbon electrode with a precipitation containing a vanadium ion or a vanadium-containing cation as an active material, it is also possible to reduce the travel distance of the active material contained in the solid precipitation and to suppress the concentration polarization (concentration overvoltage) to a low level. According to the present disclosure, it is possible to improve the electrical capacity of a VSSB, that is, the effective utilization of the battery by reducing the activation polarization (activation overvoltage) and reducing the concentration polarization (concentration overvoltage).

It is preferred that, in the VSSB of the present disclosure, effective utilization is 70% or greater. Here, the effective utilization is a numerical value that may be calculated by the following formula (i) using discharge capacity of charging up to 1.6 V at current density of 5 mA/cm² and discharging down to the cut-off voltage of 0.7 V at current density of 5 mA/cm².

Effective utilization(%)=discharge capacity/theoretical capacity×100 (i)

The theoretical capacity may be calculated by the amount of substance of the active material.

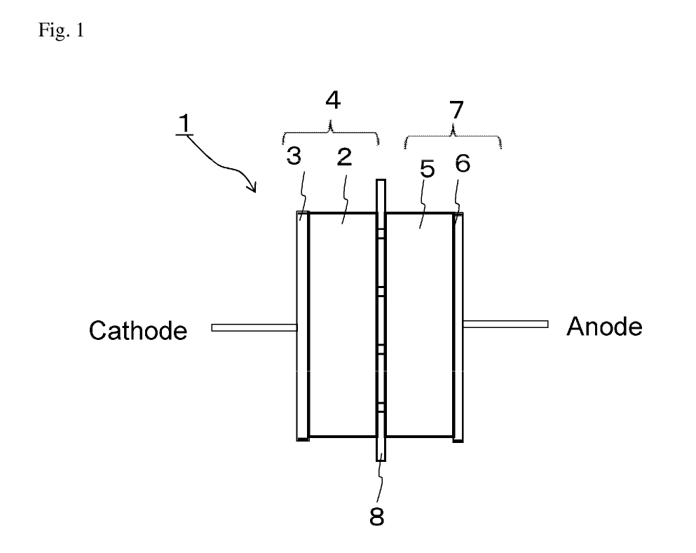

Next, a VSSB is described. FIG. 1 is a diagram illustrating a schematic configuration of a VSSB. As illustrated in FIG. 1, a VSSB 1 includes electrodes containing a carbon electrode material that carries a precipitation containing a vanadium ion or a vanadium-containing cation as an active material and a separator disposed between the electrodes. The VSSB 1 has a cathode 4 provided with a cathode current collector 2 and an extraction electrode 3, an anode 7 provided with an anode current collector 5 and an extraction electrode 6, and a separator 8 separating the cathode 4 from the anode 7. Specifically, the cathode current collector 2 is made of a carbon electrode material. The carbon electrode material constituting the current collector 2 for the cathode 4 carries a precipitation containing a vanadium ion having an oxidation number varied between pentavalence and tetravalence by reduction and oxidation reactions or a vanadium-containing cation having an oxidation number varied between pentavalence and tetravalence by reduction and oxidation reactions, as an active material. The extraction electrode 3 is disposed on a side portion of the cathode current collector 2. The anode current collector 5 is made of a carbon electrode material. The carbon electrode material constituting the anode current collector 5 carries a precipitation containing a vanadium ion having an oxidation number varied between divalence and trivalence by oxidation and reduction reactions or a vanadium-containing cation having an oxidation number varied between divalence and trivalence by oxidation and reduction reactions, as an active material. The extraction electrode 6 is disposed on a side portion of the anode current collector 5.

Vanadium is an element that may be in several different types of oxidation status, including divalence, trivalence, tetravalence, and pentavalence, and is an element having a potential difference to the extent that is useful for a battery.

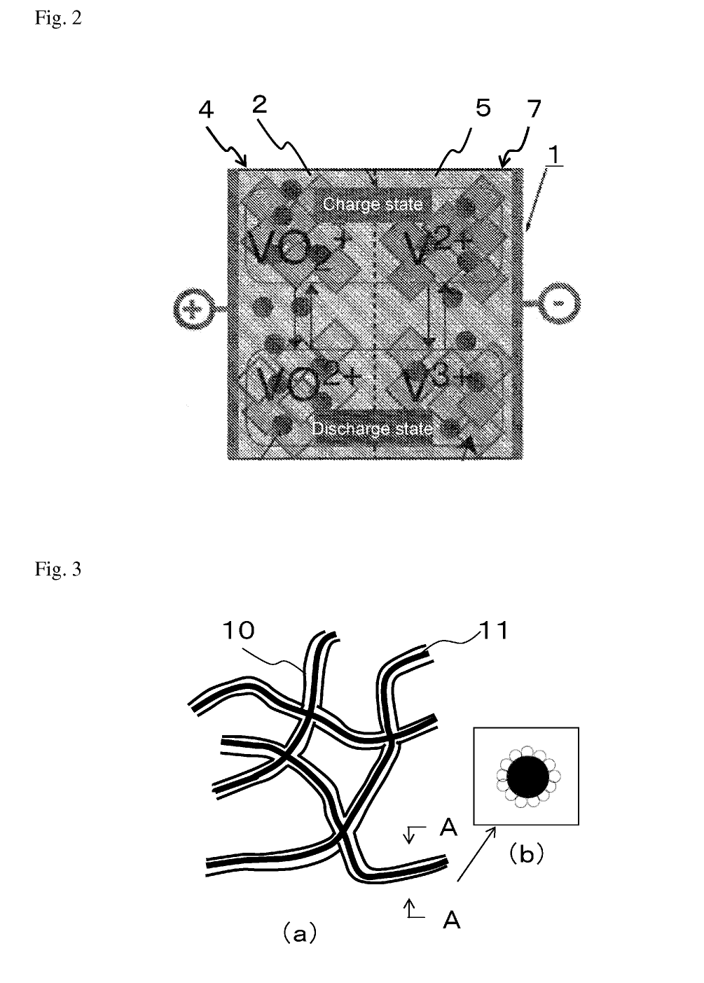

FIG. 2 is a conceptual diagram illustrating an embodiment of a VSSB of the present disclosure. As illustrated in FIG. 2, in the vanadium solid-salt battery 1 of an embodiment of the present disclosure, the carbon electrode material constituting the cathode current collector 2 carries precipitations containing vanadium-containing cations having an oxidation number varied between pentavalence and tetravalence by reduction and oxidation reactions, as an active material. In the VSSB 1 of an embodiment of the present disclosure, the carbon electrode material constituting the anode current collector 5 carries precipitations containing vanadium ions having an oxidation number varied between divalence and trivalence by oxidation and reduction reactions, as an active material.

FIG. 3 are conceptual diagrams illustrating preferred embodiments of a VSSB of the present disclosure and illustrating embodiments of using carbon fiber as the carbon electrode material. As illustrated in FIG. 3(a), in the VSSB of the present disclosure, at least a part of a surface of carbon fiber 11 constituting a carbon electrode material is coated with precipitations 10 containing vanadium ions or vanadium-containing cations as an active material.

FIG. 3(b) is a conceptual diagram illustrating a partial cross-section (A-A cross-section) of FIG. 3(a). As illustrated in FIG. 3(b), the periphery of the carbon fiber 11 is considered to be coated like a thin film with the precipitations 10 containing vanadium ions or vanadium-containing cations as an active material. The precipitations 10 containing vanadium ions or vanadium-containing cations as an active material are not precipitated in portions where the carbon fiber is confounded and the carbon fiber makes contact with each other. The precipitations 10 are not precipitated in portions where the carbon fiber is confounded or makes contact, so that it is considered that the conductive paths of the carbon electrode material constituting the current collectors are secured and the conductivity is not hindered.

Manufacture of the precipitations is described. A vanadium compound to be the precipitations is precipitated on a surface of the carbon electrode material, by drying a carbon electrode material in vacuum after impregnating the carbon electrode material with a solution containing a vanadium ion or a vanadium-containing cation, at the time when the concentration of a vanadium compound in the solution exceeds the solubility. The vanadium compound is precipitated most notably on the surface of the carbon electrode material. The precipitations are preferably precipitated like a thin film on the surface of the carbon electrode material by drying the carbon electrode material impregnated with a solution containing a vanadium compound in vacuum in such a manner that at least a part of a surface of the carbon electrode material is coated with the precipitations. The vacuum state is not particularly limited. “Drying in vacuum” means to dry the carbon electrode material impregnated with a solution containing a vanadium compound under a pressure lower than the atmospheric pressure. The pressure while drying is not particularly limited. The pressure while drying is a pressure lower than the atmospheric pressure (1.01×10⁵ Pa). The pressure while drying is preferably at a degree of vacuum of 1×10⁵ Pa or lower. The pressure while drying is more preferably at a degree of vacuum of 1×10⁴ Pa or lower in order that the precipitated vanadium compound adsorbs more strongly on the surface of the carbon electrode material. The lower limit of the pressure while drying is not particularly limited, either. The pressure while drying is preferably at a degree of vacuum of 1×10² Pa or greater in such a manner that at least a part of the surface of the carbon electrode material is coated with the precipitations approximately uniformly like a thin film. When the pressure while drying is in the range of 1×10² Pa to 1×10⁵ Pa, it is possible to make the pressure while drying to be in a vacuum state, which is lower than the atmospheric pressure, by a general purpose manner such as an aspirator and a vacuum pump. By using an aspirator or a vacuum pump, it is possible to efficiently coat at least a part of the surface of the carbon electrode material with the precipitations.

FIG. 4 is a photograph illustrating a preferred embodiment of an electrode of a VSSB of the present disclosure. FIG. 4 is a photograph, by a 200-power optical microscope, of a state where a carbon electrode material made of carbon fiber carries precipitations containing vanadium ions or vanadium-containing cations as an active material. As illustrated in FIG. 4, in at least a part of the carbon fiber, which is the carbon electrode material, the periphery of the carbon fiber is coated like a thin film with the precipitations containing vanadium ions or vanadium-containing cations as an active material.

As illustrated in FIG. 3 and FIG. 4, in the present disclosure, by coating at least a part of the surface of the carbon electrode material with the precipitations containing vanadium ions or vanadium-containing cations as an active material, it is possible to bring the electrical capacity of the VSSB closer to the theoretical capacity. In the present disclosure, by coating at least a part of the surface of the carbon electrode material with the precipitations, it is also possible to improve the effective utilization of the battery. When the carbon electrode material carries the precipitations containing vanadium ions or vanadium-containing cations as an active material in bulk, the effective utilization of the battery decreases as the amount of carried precipitations containing the active material increases. It is preferred that at least a part of the surface of the carbon electrode material, such as carbon fiber, is coated like a thin film with the precipitations containing vanadium ions or vanadium-containing cations as an active material. By coating at least a part of the surface of the carbon electrode material like a thin film with the precipitations, it is possible to suppress a decrease in the effective utilization even when the amount of carried precipitations containing the active material increases. Preferably, by coating at least a part of the surface of the carbon electrode material like a thin film with the precipitations, it is possible to make the effective utilization of the battery to be 70% or greater.

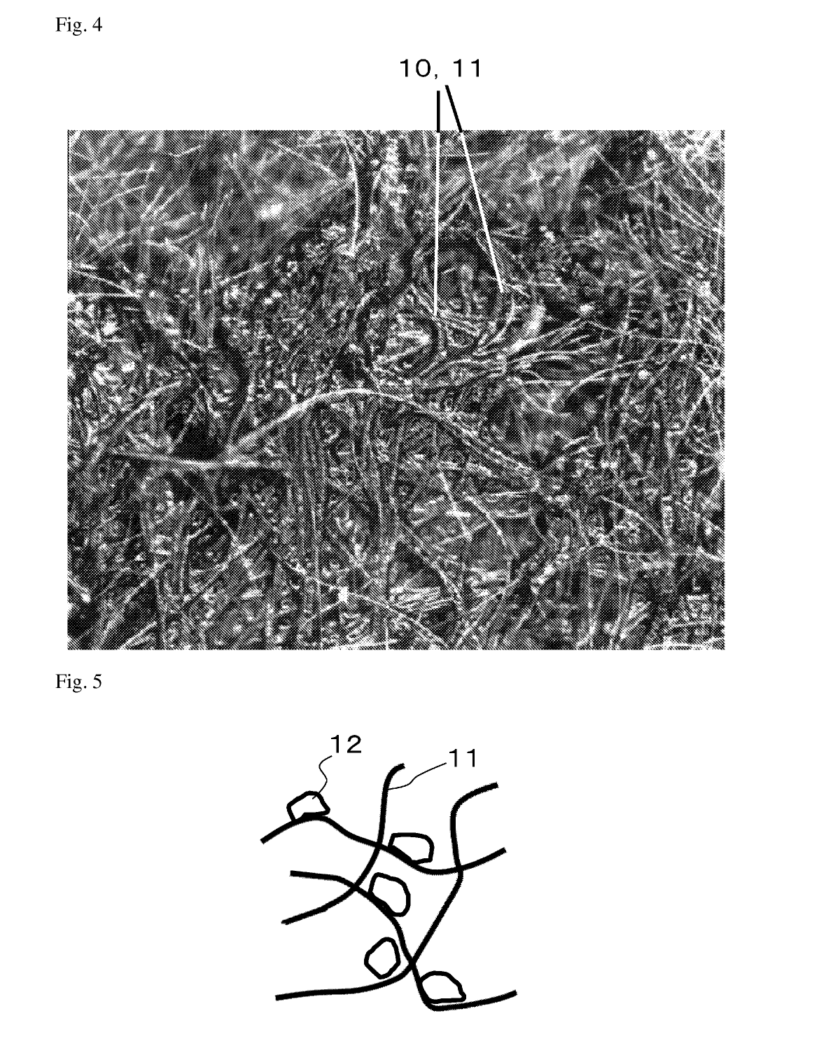

FIG. 5 illustrates a conventional VSSB. FIG. 5 is a conceptual diagram illustrating an embodiment when using carbon fiber as a carbon electrode material. As illustrated in FIG. 5, in a conventional VSSB, at least a part of the surface of the carbon electrode material is not coated with precipitations containing vanadium ions or vanadium-containing cations as an active material. In the conventional VSSB, precipitations 12 containing vanadium ions or vanadium-containing cations as an active material develop crystal growth in bulk. As illustrated in FIG. 5, the precipitations 12 are attached in bulk to a part of the surface of the carbon fiber 11. When a part of the surface of the carbon electrode material carries the precipitations in bulk, the effective utilization of the battery decreases as the amount of carried precipitations increases.

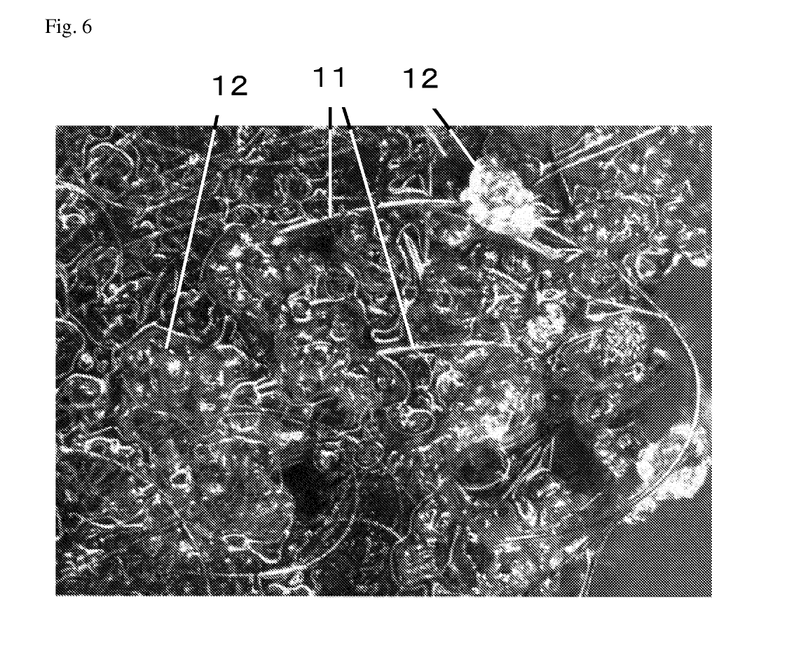

FIG. 6 illustrates an embodiment of a conventional VSSB. FIG. 6 is a photograph, by a 200-power optical microscope, of a state where a carbon electrode material made of carbon fiber carries precipitations containing vanadium ions or vanadium-containing cations as an active material. As illustrated in FIG. 6, bulk precipitations containing a vanadium ion or a vanadium-containing cation as an active material are attached on the carbon fiber.

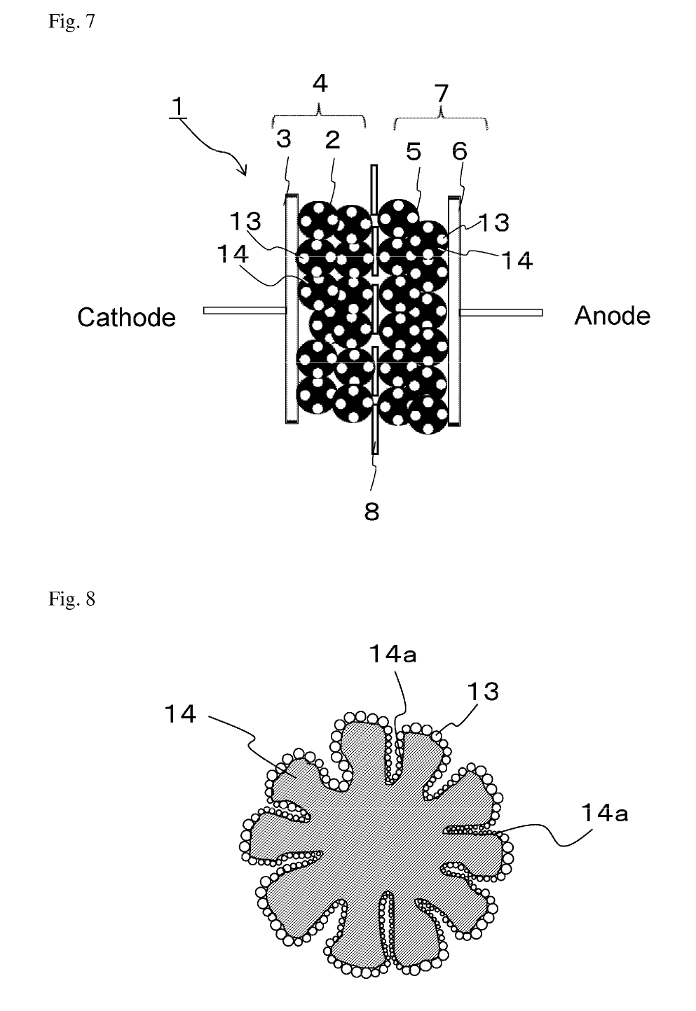

FIG. 7 illustrates another preferred embodiment of a VSSB of the present disclosure. FIG. 7 is a conceptual diagram illustrating an embodiment when using activated carbon as the carbon electrode material. In the VSSB illustrated in FIG. 7, the cathode current collector 2 or the anode current collector 5 uses activated carbon as the carbon electrode material and the VSSB 1 has the extraction electrodes 3, 6, the cathode 4, the anode 7, and the separator 8 separating the cathode 4 from the anode 7.

As illustrated in FIG. 7, in the VSSB 1 of the present disclosure, at least a part of a surface of activated carbon 14 constituting a carbon electrode material is coated with precipitations 13 containing vanadium ions or vanadium-containing cations as an active material.

FIG. 8 is a conceptual diagram illustrating a cross-section of the activated carbon 14 constituting the carbon electrode material. As illustrated in FIG. 8, at least a part of a surface of the granular activated carbon 14 is coated with the precipitations 13 containing a vanadium ion or a vanadium-containing cation as an active material. As illustrated in FIG. 8, at least a part of the micropores 14a of the granular activated carbon 14 is filled with the precipitations 13. In the present disclosure, a surface of activated carbon means to include the surfaces of the micropores of the activated carbon.

The activated carbon is produced to have at least a part of a surface coated with the precipitations or at least a part of micropores filled with the precipitations. Firstly, the activated carbon is activated in vacuum to produce a carbon electrode material. Next, the carbon electrode material is impregnated with a solution containing a vanadium compound, and after that, the carbon electrode material impregnated with the solution containing a vanadium compound is dried. It is preferred that the carbon electrode material impregnated with the solution containing a vanadium compound is dried in vacuum. The state of vacuum for drying is not particularly limited. The state of vacuum for drying may be at a pressure lower than the atmospheric pressure. Regarding the carbon electrode material impregnated with the solution containing a vanadium compound, the activated carbon may be activated or dried under a pressure lower than the atmospheric pressure. The pressure while drying is not particularly limited. The pressure while drying is preferably at a degree of vacuum of 1×10⁵ Pa or lower and more preferably at a degree of vacuum of 1×10⁴ Pa or lower. The lower limit of the pressure while drying is not particularly limited, either. The pressure while drying is preferably at a degree of vacuum of 1×10² Pa or greater.

In the present disclosure, a VSSB has a carbon electrode material, constituting a current collector, carrying precipitations containing a vanadium ion or a vanadium-containing cation as an active material. The VSSB may also contain a sulfuric acid aqueous solution as a small amount of electrolysis solution. The amount of the sulfuric acid aqueous solution is an amount neither too much nor too little to allow the battery to be from 0% to 100% of the state of charge and discharge (hereinafter, may also be referred to as SOC (state of charge)). The amount of the sulfuric acid aqueous solution contained in the VSSB is, for example, 70 mL of 2 M sulfuric acid in terms of 100 g of the precipitations (vanadium compound) carried by the carbon electrode material.

(Anode)

It is preferred that an anode of the VSSB has a carbon electrode material carrying a precipitation containing, as an active material, a vanadium ion or a vanadium-containing cation having an oxidation number varied between divalence and trivalence by oxidation and reduction reactions. Here, it is preferred that the precipitations are precipitated from a solution that contains vanadium ions having an oxidation number varied between divalence and trivalence or vanadium-containing cations having an oxidation number varied between divalence and trivalence. It is also preferred that the precipitations are precipitated from a solution that contains a vanadium compound selected from the group consisting of vanadium salt that contains a vanadium ion or a cation having an oxidation number varied between divalence and trivalence and complex salt that contains vanadium ions or cations having an oxidation number varied between divalence and trivalence. Such vanadium compound may be exemplified by a vanadium sulfate (II) n hydrate, a vanadium sulfate (III) n hydrate, and the like. In the present disclosure, n denotes 0 or an integer from 1 to 6.

It is preferred that the precipitations carried by the carbon electrode material are precipitated from an addition of a sulfuric acid aqueous solution to a vanadium sulfate (II) n hydrate, a vanadium sulfate (III) n hydrate, or a mixture of them. The concentration and the like of the sulfuric acid aqueous solution are not particularly limited. It is preferred that dilute sulfuric acid having a sulfuric acid concentration of less than 90 mass % and the like are used for the sulfuric acid aqueous solution. The amount of the sulfuric acid aqueous solution to be added to the vanadium compound is not particularly limited. The sulfuric acid aqueous solution is in an amount neither too much nor too little to allow the battery using an electrode that carries the precipitations precipitated from the vanadium compound to be from 0% to 100% of the SOC. The amount of the sulfuric acid aqueous solution is, for example, 70 mL of 2 M sulfuric acid in terms of 100 g of the precipitations (vanadium compound) carried by the carbon electrode material.

The concentration and the like of the vanadium compound to make the carbon electrode material carry the precipitations are not particularly limited. It is preferred that the vanadium compound is in a state of having hardness or viscosity to be attached to the carbon electrode material. The vanadium compound may also be solid or semi-solid. Here, to be semi-solid includes slurry obtained by adding a vanadium compound to a sulfuric acid aqueous solution or the like and gel obtained by adding a vanadium compound to silica.

(Cathode)

It is preferred that a cathode of the VSSB has a carbon electrode material carrying a precipitation containing a vanadium ion having an oxidation number varied between pentavalence and tetravalence by reduction and oxidation reactions or a vanadium-containing cation having an oxidation number varied between pentavalence and tetravalence by reduction and oxidation reactions, as an active material. Here, it is preferred that the precipitations are precipitated from a solution that contains vanadium ions having an oxidation number varied between pentavalence and tetravalence or vanadium-containing cations having an oxidation number varied between pentavalence and tetravalence. It is also preferred that the precipitations are precipitated from a solution that contains a vanadium compound selected from the group consisting of vanadium salt that contains a vanadium ion or a cation having an oxidation number varied between pentavalence and tetravalence and complex salt that contains a vanadium ion or a cation having an oxidation number varied between pentavalence and tetravalence. Such vanadium compound may be exemplified by a vanadium oxy(VO²⁺)sulfate (IV) n hydrate, a vanadium dioxy(VO₂⁺)sulfate (V) n hydrate, and the like. In the present disclosure, n denotes 0 or an integer from 1 to 6.

It is preferred that the precipitations carried by the carbon electrode material are precipitated from an addition of a sulfuric acid aqueous solution to a vanadium oxysulfate (IV) n hydrate, a vanadium dioxysulfate (V) n hydrate, or a mixture of them. The concentration and the like of the sulfuric acid aqueous solution are not particularly limited. It is preferred that dilute sulfuric acid having a sulfuric acid concentration of less than 90 mass % and the like are used for the sulfuric acid aqueous solution. The amount of the sulfuric acid aqueous solution to be added to the vanadium compound is not particularly limited. The amount of the sulfuric acid aqueous solution is an amount neither too much nor too little to allow the battery to be from 0% to 100% of the SOC. The sulfuric acid aqueous solution is, for example, 70 mL of 2 M sulfuric acid in terms of 100 g of the precipitations (vanadium compound) carried by the carbon electrode material.

The concentration and the like of the vanadium compound to make the carbon electrode material carry the precipitations are not particularly limited. It is preferred that the vanadium compound is in a state of having hardness or viscosity to be attached to the carbon electrode material. The vanadium compound may also be solid or semi-solid. Here, to be semi-solid includes slurry obtained by adding a vanadium compound to a sulfuric acid aqueous solution or the like and gel obtained by adding a vanadium compound to silica.

(Carbon Electrode Material)

It is preferred that the carbon electrode material to carry the precipitation is carbon fiber or activated carbon. The carbon electrode material may be exemplified by, for example, carbon felt using carbon short fiber, carbon fiber fabric using carbon long fiber, carbon fiber knitted fabric, activated carbon, graphite powder, carbon black, and the like.

(Separator)

The VSSB of the present disclosure has a separator that separates the cathode from the anode. It is preferred that the separator is a porous film, non-woven fabric, or an ion exchange membrane. In the present disclosure, an ion exchange membrane means a film having a function of letting specific ions pass through. The porous film may be exemplified by, for example, a polyethylene microporous film (manufactured by Asahi Kasei Corp.) and the like. The non-woven fabric may be exemplified by, for example, NanoBase (manufactured by Mitsubishi Paper Mills Ltd.) and the like. The ion exchange membrane may be exemplified by, for example, SELEMION® APS (manufactured by Asahi Glass Co., Ltd.) and the like.

In the VSSB of the present disclosure, the following reactions occur in the anode and the cathode.

Cathode: VOX₂·nH₂O(s) [symbol] VO₂X·nH₂O(s)+HX+H⁺+e⁻ (3)

Anode: VX₃·nH₂O(s)+e⁻ [symbol] 2VX₂·nH₂O(s)+X⁻ (4)

In the reaction formula produced in the cathode and the anode, X denotes monovalent anions. It should be noted that a coupling coefficient (1/m) may be understood to be considered even when X is an m-valent anion. Here, “ [symbol] ” means equilibrium, and the equilibrium in the reaction formula means a state where, in a reversible reaction, the variation of products matches the variation of starting materials. In the reaction formula, n may be various values.

A battery is charged as the oxidation and reduction reactions proceed in the cathode and the anode by applying a voltage from outside. A battery is discharged as the reduction and oxidation reactions proceed respectively by connecting electrical load between the cathode and the anode.

In the VSSB of the present disclosure, one reduction/oxidation pair is formed with, for example, precipitations containing vanadium ions varied between divalence and trivalence as active materials. In the VSSB, another reduction/oxidation pair is formed with precipitations containing vanadium-containing cations varied between pentavalence and tetravalence as active materials. The VSSB is capable of securing high electromotive force. The VSSB does not precipitate an electrolyte by a reduction/oxidation reaction as it does when using an electrolyte solution, and it is possible to suppress generation of dendrite. The VSSB is capable of improving the safety and the durability of the battery.

For the precipitation containing vanadium, a precipitation containing a vanadium ion having an arbitrary oxidation number from divalence to pentavalence or a vanadium-containing cation having an arbitrary oxidation number from divalence to pentavalence may be prepared. Accordingly, a VSSB in a charge state of 0% in an initial state may be manufactured. A VSSB in a charge state of 100% in an initial state may also be manufactured.

For the vanadium compound to be precipitated on the anode, vanadium oxide (vanadyl: VOSO₄·H₂O) sulfate is used. For the vanadium compound to be precipitated on the cathode, vanadium sulfate (V₂(SO₄)₃·nH₂O) is used. Reactions of respective vanadium compounds in the anode and the cathode are shown below.

2VOSO₄·nH₂O(s) [symbol] (VO₂)₂SO₄·nH₂O(s)+SO₄²⁻+4H⁺+2e⁻ (5)

V₂(VO₄)₃·nH₂O(s)+2e⁻ [symbol] 2VSO₄·nH₂O(s)+SO₄²⁻ (6)

As an embodiment of the VSSB of the present disclosure, a reaction in the cathode is shown below.

VOSO₄·nH₂O(s) [symbol] VOSO₄·nH₂O(aq) [symbol] VOSO₄(aq)+nH₂O(aq) (7)

(VO₂)₂·SO₄·nH₂O(s) [symbol] (VO₂)₂·SO₄·nH₂O(aq) [symbol] (VO₂)₂SO₄(aq)+nH₂O(aq) (8)

VO²⁺(aq)+VO₂⁺(aq) [symbol] V₂O₃³⁺(aq) (9)

VO²⁺(aq)+SO₄²⁻(aq) [symbol] VOSO₄(aq) (10)

2VO²⁺(aq)+SO₄²⁻(aq) [symbol] (VO₂)₂SO₄(aq) (11)

As an embodiment of the VSSB of the present disclosure, a reaction in the anode is shown below.

V₂(SO₄)₃·nH₂O(s) [symbol] V₂(SO₄)₃·nH₂O(aq) [symbol] V₂(SO₄)₃+nH₂O(aq) (12)

VSO₄·nH₂O(s) [symbol] VSO₄·nH₂O(aq) [symbol] VSO₄(aq)+nH₂O(aq) (13)

2V³⁺(aq)+3SO₄²⁻ [symbol] V₂(SO₄)₃(aq) (14)

As an embodiment of the VSSB, a VSSB in a charge state of 0% is produced by carrying a precipitation precipitated from a vanadium sulfate (III) n hydrate in the anode and carrying a precipitation precipitated from a vanadium oxysulfate (IV) n hydrate in the cathode. In the VSSB, VO²⁺(aq) expressed in the formula (1) is generated in the cathode from VOSO₄(aq) generated by the reaction expressed in the formula (7). In the VSSB, V³⁺(aq) expressed in the formula (2) is also generated in the anode from V₂(SO₄)₃ generated by the reaction expressed in the formula (12).

Next, when a sufficiently large voltage is applied between the cathode and the anode of the VSSB in a charge state of 0%, VO²⁺(aq) in the cathode solution is oxidized to VO₂⁺(aq) and meanwhile V³⁺(aq) in the anode solution is reduced to V²⁺(aq) for charging. When electrical load is connected between the cathode and the anode after charging is completed, the reaction proceeds in a direction opposite to the charging and the battery is discharged.

[Method of Manufacturing Vanadium Solid-Salt Battery (VSSB)]

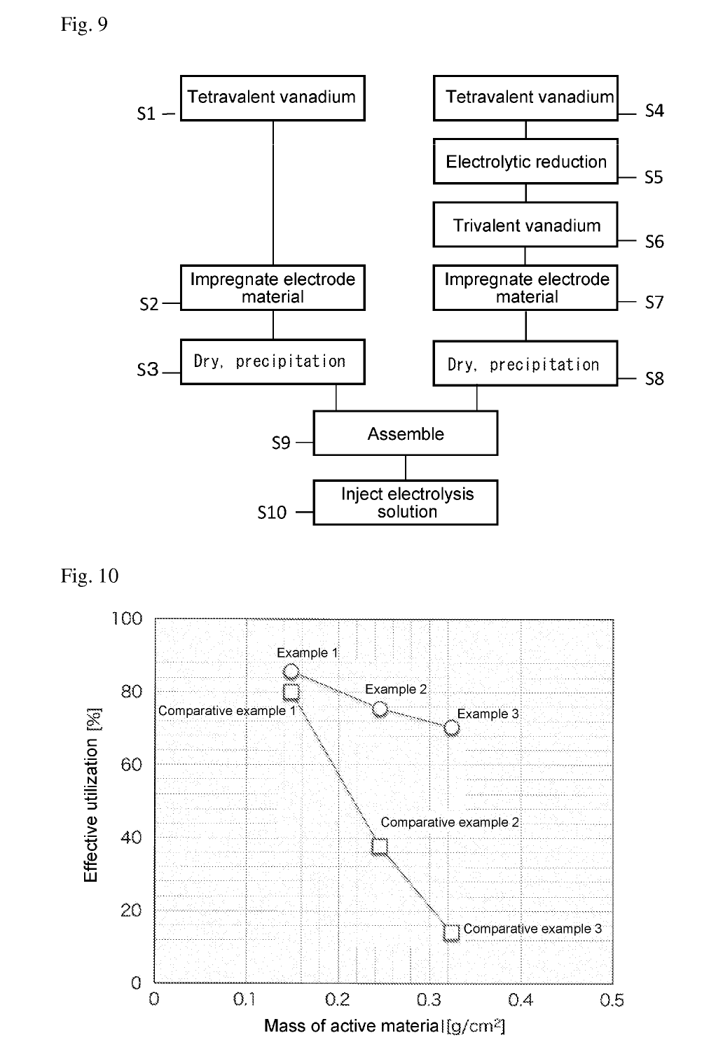

Next, a method of manufacturing a vanadium solid-salt battery (VSSB) is described. FIG. 9 is a flow chart illustrating a method of manufacturing a VSSB. As illustrated in FIG. 9, a VSSB is manufactured by firstly producing a cathode and an anode, and after that, assembling the cathode and the anode, and injecting a required amount of electrolysis solution. The method of manufacturing a VSSB includes the step (S2 or S7) of impregnating a carbon electrode material with a solution containing a vanadium ion or a vanadium-containing cation to be an active material. The method of manufacturing a VSSB includes the step (S3 or S8) of carrying, by drying the carbon electrode material in vacuum to coat at least a part of a surface of the carbon electrode material with a precipitation containing the vanadium ion or the vanadium-containing cation to be the active material, the precipitation in the carbon electrode material. In the step of impregnating a carbon electrode material, the concentration of the vanadium compound in the solution is not particularly limited. For example, when the carbon electrode material is carbon felt, the concentration of the vanadium compound in the solution is preferably from 1 to 3 M (mol/L) while it depends on the weight per area and the thickness of the carbon electrode material. The carbon electrode material is preferably impregnated with a solution containing a vanadium compound from 1 to 3 M (mol/L). The concentration of the vanadium compound in the solution is more preferably from 1.5 to 2.5 M (mol/L).

Specifically, the method of manufacturing a VSSB includes steps S1 through S9 as the step of producing a VSSB. Steps S1 through S3 are the step of producing an anode. Steps S4 through S8 are the step of producing a cathode. Step 9 is the step of assembling a battery.

(Step S1)

In step S1, a solution that contains tetravalent vanadium ions or cations containing vanadium in a tetravalent state is prepared to use the solution directly in next step S2. Alternatively, step S1 is a step in which tetravalent vanadium ions or a solid active material containing vanadium in a tetravalent state is obtained by drying the solution that contains tetravalent vanadium ions or cations containing vanadium in a tetravalent state in an oxygen containing environment. Here, the “tetravalent vanadium ions or cations containing vanadium in a tetravalent state” may be exemplified by V⁴⁺ and VO₂⁺. The “solution that contains tetravalent vanadium ions or cations containing vanadium in a tetravalent state” may be exemplified by a vanadium oxysulfate (IV) aqueous solution (VOSO₄ y hydrate). In the present disclosure, the meaning of being “in an oxygen containing environment” includes being in the air.

The solution that contains tetravalent vanadium ions or cations containing vanadium in a tetravalent state may be electrolytically oxidized to produce the solution that contains pentavalent vanadium ions or cations containing vanadium in a pentavalent state. The solution that contains pentavalent vanadium ions or cations containing vanadium in a pentavalent state may also be used directly in next step S2. The “solution that contains pentavalent vanadium ions or cations containing vanadium in a pentavalent state” may be exemplified by a vanadium dioxysulfate (V) aqueous solution ((VO₂)₂SO₄ n hydrate).

The method of carrying out electrolytic oxidation may include, for example, a method in which electrolytic oxidation of the solution that contains tetravalent vanadium ions or cations containing vanadium in a tetravalent state at a constant current of 1 A is carried out for 2.5 hours. It is confirmed that the color of the solution that contains tetravalent vanadium ions or cations containing vanadium in a tetravalent state has completely changed from blue to yellow. Next, the solution that contains tetravalent vanadium ions or cations containing vanadium in a tetravalent state is left in the air for 12 hours. After that, from the solution that contains tetravalent vanadium ions or cations containing vanadium in a tetravalent state, the solution is obtained that contains pentavalent vanadium ions or cations containing vanadium in a pentavalent state. In addition, by further drying the solution, pentavalent vanadium ions or a solid material containing vanadium in a pentavalent state may be obtained.

(Step S2)

Step S2 is a step in which a carbon electrode material is impregnated with the solution obtained in step S1. In step S2, the carbon electrode material is immersed in the solution that contains tetravalent vanadium ions or cations containing vanadium in a tetravalent state obtained in step S1 to let the carbon electrode material soak up the solution. The concentration of the vanadium compound in the solution with which the carbon electrode material is impregnated is not particularly limited. For example, when the carbon electrode material is carbon felt, the concentration of the vanadium compound in the solution with which the carbon electrode material is impregnated is preferably from 1 to 3 M (mol/L) and more preferably from 1.5 to 2.5 M (mol/L) while it depends on the weight per area and the thickness of the carbon electrode material.

(Step S3)

Step S3 is a step in which the precipitation is carried by drying the carbon electrode material in vacuum, the carbon electrode is impregnated with the solution that contains tetravalent vanadium ions or cations containing vanadium in a tetravalent state obtained in step S2. In step S3, the carbon electrode material that is impregnated with the solution that contains tetravalent vanadium ions or cations containing vanadium in a tetravalent state is dried in vacuum. In step S3, by drying the solution, excess liquid is evaporated. Step S3 is the step of carrying a precipitation in the carbon electrode material to coat at least a part of a surface of the carbon electrode material with the precipitation containing vanadium in a tetravalent state. Here, the vacuum state means that the environment to dry the carbon electrode material is under a pressure lower than the atmospheric pressure. The pressure while drying is not particularly limited. The pressure while drying is a pressure lower than the atmospheric pressure (1.01×10⁵ Pa). The pressure while drying is more preferably at a degree of vacuum of 1×10⁵ Pa or lower. The pressure while drying is more preferably at a degree of vacuum of 1×10⁴ Pa or lower in such a manner that the precipitated vanadium compound adsorbs on the surface of the carbon electrode material more strongly. Although the lower limit of the pressure while drying is not particularly limited, either, it is preferred to be at a degree of vacuum of 1×10² Pa or greater in such a manner that at least a part of the surface of the carbon electrode material is coated with the precipitation approximately uniformly like a thin film. When the pressure while drying is in the range of 1×10² Pa to 1×10⁵ Pa, it is possible to make the pressure while drying to be a vacuum state lower than the atmospheric pressure by a general purpose manner, such as an aspirator and a vacuum pump. As the pressure while drying is from 1×10² Pa to 1×10⁵ Pa, at least a part of the surface of the carbon electrode material is coated with the precipitation efficiently.

In step S3, a carbon electrode material for the cathode is obtained that carries a solid or semi-solid precipitation containing a vanadium ion having an oxidation number varied between pentavalence and tetravalence by a reduction/oxidation reaction. Here, “excess liquid is evaporated” means that a small amount of sulfuric acid aqueous solution is remained and liquid other than that is evaporated. The amount of the sulfuric acid aqueous solution is an amount neither too much nor too little to allow the battery to be from 0% to 100% of the SOC.

(Step S4)

Step S4 is, similar to step S1, a step in which a solution that contains tetravalent vanadium ions or cations containing vanadium in a tetravalent state is prepared.

(Step S5)

Step S5 is a step in which a solution that contains trivalent vanadium ions or cations containing vanadium in a trivalent state is obtained by electrolytic reduction of the solution that contains tetravalent vanadium ions or cations containing vanadium in a tetravalent state obtained in step S4. The solution that contains trivalent vanadium ions or cations containing vanadium in a trivalent state may be exemplified by a vanadium sulfate (III) aqueous solution (V₂(SO₄)₃ n hydrate).

The method of carrying out electrolytic reduction may include a method in which electrolytic reduction of a solution that contains tetravalent vanadium ions or cations containing vanadium in a tetravalent state at a constant current of 1 A is carried out for five hours. After it is confirmed that the color of the solution that contains tetravalent vanadium ions or cations containing vanadium in a tetravalent state has completely changed from blue to purple, the solution is left in the air for 12 hours to obtain the solution that contains trivalent vanadium ions or cations containing vanadium in a trivalent state. This solution is in green. The electrolytic reduction may also be carried out in bubbling of noble gas, such as argon. Further, the electrolytic reduction may also be carried out while keeping the solution temperature at a constant temperature. The constant temperature is preferably from 10° C. to 30° C. Platinum plates are used as the electrodes when carrying out electrolytic reduction, and an ion exchange membrane, such as SELEMION® APS (manufactured by Asahi Glass Co., Ltd.), for example, may be used as the separator to separate between the two electrodes.

(Step S6)

Step S6 is a step in which the solution that contains trivalent vanadium ions or cations containing vanadium in a trivalent state is obtained by electrolytic reduction in Step S5. Electrolytic reduction of the solution that contains tetravalent vanadium ions or cations containing vanadium in a tetravalent state may also be carried out to obtain the solution that contains divalent vanadium ions or cations containing vanadium in a divalent state. The solution that contains divalent vanadium ions or cations containing vanadium in a divalent state may be exemplified by a vanadium sulfate (II) solution (VSO₄ n hydrate).

Electrolytic reduction at a low current is carried out for five hours, and it is confirmed that the color of the solution that contains divalent vanadium ions or cations containing vanadium in a divalent state has completely changed from blue to purple. The solution that contains divalent vanadium ions or cations containing vanadium in a divalent state is left in the air for 12 hours. After that, from the solution that contains tetravalent vanadium ions or cations containing vanadium in a tetravalent state, the solution is obtained that contains divalent vanadium ions or cations containing vanadium in a divalent state. This solution is in green.

(Step 7)

Step S7 is a step in which a carbon electrode material is impregnated with the solution that contains trivalent vanadium ions or cations containing vanadium in a trivalent state or with the solution that contains divalent vanadium ions or cations containing vanadium in a divalent state obtained in step S6. The concentration of the vanadium compound in the solution to let the carbon electrode material soak up is not particularly limited. For example, when the carbon electrode material is carbon felt, the concentration of the vanadium compound in the solution with which the carbon electrode material is impregnated is preferably from 1 to 3 M (mol/L) and more preferably from 1.5 to 2.5 M (mol/L) while it depends on the weight per area and the thickness of the carbon electrode material.

(Step S8)

Step S8 is a step in which the precipitation is carried by drying the carbon electrode material obtained in step S7 in vacuum. In step S8, excess liquid is evaporated by drying, in vacuum, the carbon electrode material impregnated with the solution that contains trivalent vanadium ions or cations containing vanadium in a trivalent state. Step S8 is the step of carrying, to coat at least a part of the surface of the carbon electrode material with precipitations containing vanadium in a trivalent or divalent state, the precipitation in the carbon electrode material. Here, the vacuum state means that the environment to dry the carbon electrode material is under a pressure lower than the atmospheric pressure. Although the pressure while drying is not particularly limited, similar to step S3, the degree of vacuum is preferably 1×10⁵ Pa or lower and the degree of vacuum is more preferably 1×10⁴ Pa or lower. Although the lower limit of the degree of vacuum is not particularly limited, either, the degree of vacuum is preferably 1×10² Pa or greater.

In step S8, a carbon electrode material for the anode is obtained that carries a solid or semi-solid precipitation containing vanadium ions having an oxidation number varied between trivalence and divalence or cations containing vanadium having an oxidation number varied between trivalence and divalence. Here, “excess liquid is evaporated” means that a small amount of sulfuric acid aqueous solution is remained and liquid other than that is evaporated. The amount of the sulfuric acid aqueous solution is an amount neither too much nor too little to allow the battery to be from 0% to 100% of the SOC.

(Step S9)

Step S9 is the step of assembling a battery by using a current collector made of the carbon electrode material that carries the precipitation for the cathode, a current collector made from the carbon electrode material that carries the precipitation for the anode, a separator, an extraction electrode for the cathode, and an extraction electrode for the anode.

For the cathode, a current collector is used where, for example, precipitations containing cations that contain vanadium in a tetravalent oxidation state is carried in the carbon electrode material. For the anode, a current collector is used where, for example, precipitations containing vanadium ions in a trivalent oxidation state is carried in the carbon electrode material. The cathode and the anode constitute a redox pair. It is possible to obtain a VSSB in a charge state of 0% immediately after production while the VSSB has high storage capacity and also has high energy density.

For the cathode, a current collector may also be used where, for example, precipitations containing cations that contain vanadium in a pentavalent oxidation state is carried in the carbon electrode material. For the anode, a current collector may also be used where precipitations containing vanadium ions in a divalent oxidation state is carried in the carbon electrode material. The cathode and the anode constitute a redox pair. It is possible to obtain a VSSB in a charge state of 100% immediately after production while the VSSB has high storage capacity and also has high energy density.

The precipitation may contain sulfate, chloride, or fluoride as counter ions to the vanadium salt or the complex salt.

For example, when chloride is contained as counter ions, the following reactions occur on the cathode side.

VOCl₂·nH₂O(s) [symbol] VOCl₂·nH₂O(aq) [symbol] VOCl₂(aq)+nH₂O(aq) (15)

(VO₂)₂Cl₂·nH₂O(s) [symbol] (VO₂)₂Cl₂·nH₂O(aq) [symbol] (VO₂)₂Cl₂(aq)+nH₂O(aq) (16)

VO²⁺(aq)+VO₂⁺(aq) [symbol] V₂O₃³⁺(aq) (17)

VO²⁺(aq)+2Cl⁻(aq) [symbol] VOCl₂(aq) (18)

2VO²⁺(aq)+2Cl⁻(aq) [symbol] (VO₂)₂Cl₂(aq) (19)

For example, when chloride is contained as counter ions, the following reactions occur on the anode side.

V₂Cl₃·nH₂O(s) [symbol] V₂Cl₃·nH₂O(aq) [symbol] V₂Cl₃+nH₂O(aq) (20)

VCl₂·nH₂O(s) [symbol] VCl₂·nH₂O(aq) [symbol] Cl₂(aq)+nH₂O(aq) (21)

2V³⁺(aq)+6Cl⁻ [symbol] V₂Cl₃(aq) (22)

When fluoride is used as counter ions, Cl in the formula (15) through formula (22) may be replaced with F.

In the VSSB thus configured, high safety is secured while high storage capacity is kept and also high energy density is kept.

Since it is possible to obtain stable energy efficiency in a relatively wide range in the precipitations for the cathode and the precipitations for the anode, it is possible to obtain a secondary battery also suitable for consumer use.

[Behavior of VSSB (1)]

Behavior of the VSSB thus configured is described with reference to FIG. 2.

The anode 7 includes a carbon electrode material that carries the precipitations precipitated from the solution that contain solid powder of vanadium sulfate (III). The cathode 4 includes a carbon electrode material that carries the precipitations precipitated from the solution that contain solid powder of vanadyl sulfate (IV). The VSSB including the anode 7 and the cathode 4 is in a charge state of 0% in the initial state. The solid powder of vanadium sulfate (III) (V₂(SO₄)₃·nH₂O) is in green. The solid powder of vanadyl sulfate (IV) (VOSO₄·nH₂O) is in blue.

As illustrated in FIG. 2, in the cathode in the initial state, VO₂⁺(aq) expressed in the formula (1) is generated from (VO₂)₂SO₄(aq) that is particularly generated from the formula (8) among the formulae (7) through (11).

In the anode in the initial state, V³⁺(aq) is generated from the formula (2) from V₂(SO₄)₃ that is particularly generated from the formula (12) among the formula (12) through formula (14).

That is, the VSSB is in the “discharge state” illustrated in FIG. 2 immediately after production.

Next, when a sufficiently large voltage is applied between the cathode and the anode, the following reaction proceeds in the cathode to oxidize V⁴⁺(aq) to V⁵⁺(aq).

VO²⁺(aq)+H₂O→VO₂⁺(aq)+e⁻+2H⁺ (23)

In the meanwhile, the following reaction proceeds in the anode to reduce V³⁺(aq) to V²⁺(aq) for charging.

V³⁺(aq)+e⁻V²⁺(aq) (24)

The potential difference between the electrodes immediately after start of charging is approximately 1.0 V. After that, the voltage continues gradual rise during the charge, and the open circuit voltage of the battery becomes approximately 1.58 V at the time of charge completion. The VSSB in this state is in the “charge state” illustrated in FIG. 2.

When electrical load is connected between the cathode and the anode after charging is completed, the following reaction proceeds in a direction opposite to the charging and the battery is discharged.

VO²⁺(aq)+H₂O←VO₂⁺(aq)+e⁻+2H⁺ (25)

V³⁺(aq)+e⁻←V²⁺(aq) (26)

[Behavior of VSSB (2)]

Next, behavior (2) of a VSSB is described. The anode includes a carbon electrode material that carries the precipitations precipitated from the solution that contain solid powder of vanadium sulfate (II). The cathode includes a carbon electrode material that carries the precipitations precipitated from the solution that contain solid powder of vanadyl sulfate (V). The VSSB has an advantage of being capable of discharge from immediately after production while exhibiting actions and effects in all embodiments.

Bringing the reactions in the VSSB together, the following reactions occur in the cathode 4.

VO²⁺(aq)+H₂O [symbol] VO₂⁺(aq)+e⁻+2H⁺ (1)

VOSO₄·nH₂O(s) [symbol] VOSO₄·nH₂O(aq) [symbol] VOSO₄(aq)+nH₂O(aq) [symbol] VO²⁺(aq)+SO₄²⁻(aq)+nH₂O(aq) (27)

(VO₂)₂SO₄·nH₂O(s) [symbol] (VO₂)₂SO₄·nH₂O(aq) [symbol] (VO₂)₂SO₄(aq)+nH₂O(aq) [symbol] 2VO₂⁺(aq)+SO₄²⁻(aq)+nH₂O(aq) (28)

In the anode 7, the following reactions occur.

V³⁺(aq)+e⁻ [symbol] V²⁺(aq) (29)

V₂(SO₄)₃·nH₂O(s) [symbol] V₂(SO₄)₃·nH₂O(aq) [symbol] V₂(SO₄)₃+nH₂O(aq) [symbol] 2V³⁺(aq)+3SO₄²⁻(aq)+nH₂O(aq) (30)

VSO₄·nH₂O(s) [symbol] VSO₄·nH₂O(aq) [symbol] VSO₄(aq)+nH₂O(aq) [symbol] V²⁺(aq)+SO₄²⁻(aq)+nH₂O(aq) (31)

A VSSB that is manufactured in the method of manufacturing a VSSB of the present disclosure and shows the operating state of the behavior (2) of the VSSB is capable of achieving high energy density by a reduction/oxidation reaction produced by the vanadium ion or the vanadium-containing cation as the active material. In the present disclosure, at least a part of the surface of the carbon electrode material is coated with the precipitations containing vanadium ions or vanadium-containing cations as an active material, thereby increasing the concentration of the active material present near the surface of the carbon electrode material to suppress activation polarization (activation overvoltage) related to the reaction (charge transfer reaction) occurring on the surface of the carbon electrode material. In addition, in the present disclosure, at least a part of the surface of the carbon electrode material is coated with the precipitations, thereby reducing the travel distance of the active material contained in the precipitations to suppress the concentration polarization (concentration overvoltage) to a low level, thus it is possible to increase the electrical capacity. That is, according to the present disclosure, it is possible to provide a VSSB having high effective utilization.

### EXAMPLES

Next, specific modes of the present disclosure are described with Examples while the present disclosure is not limited by these examples.

(Solution for Cathode)

The solution for the cathode was obtained by adding 2 M (2 mol/L) sulfuric acid to 566 g of a vanadium sulfate (IV) n hydrate (VOSO₄·nH₂O) (VOSO₄ content: 72%) (VOSO₄: 408 g, 2.5 mol) to make it 1 L and stirring it.

(Solution for Anode)

A preparatory solution for the solution for the anode was produced by adding sulfuric acid to 566 g of a vanadium sulfate (IV) n hydrate (VOSO₄·nH₂O) similar to the solution for the cathode to make it 1 L and stirring it. The preparatory solution was subjected to electrolytic reduction. For the working electrode for electrolytic reduction, a platinum plate was used. For the separator for electrolytic reduction, an ion exchange membrane (SELEMION® APS manufactured by Asahi Glass Co., Ltd.) was used. Firstly, the preparatory solution was transferred to a beaker-type cell. Next, the preparatory solution in the beaker-type cell was subjected to bubbling with argon (Ar) gas. After that, the preparatory solution was subjected to electrolytic reduction at a constant current of 1 A for five hours by maintaining the temperature at 15° C. in Ar gas bubbling. After that, the preparatory solution was transferred from the beaker-type cell to a petri dish. The preparatory solution transferred to the petri dish was left in the air for 12 hours. The inventors visually confirmed that the color of the preparatory solution had completely changed from purple to green. Next, the preparatory solution was dried at room temperature under a reduced pressure for one week. After that, 854 g of a vanadium sulfate (III) n hydrate (V₂(SO₄)₃·nH₂O) (V₂(SO₄)₃ content: 57.1%) (V₂(SO₄)₃: 488 g, 2.5 mol) was obtained from the preparatory solution. The solution for the anode was obtained by adding 2 M sulfuric acid to the vanadium sulfate (III) n hydrate (V₂(SO₄)₃·nH₂O) to make it 1 L and stirring it.

(Carbon Electrode Material)

For the carbon electrode material, commercially available carbon felt having the weight per area of 330 g/cm² and the thickness of 4.2 mm was used.

(Separator: Porous Film)

For the separator, a polyethylene microporous film (manufactured by Asahi Kasei Corp.) was used.

### Example 1

Carbon electrode materials for the cathode and the anode were impregnated with 0.3 mL of a solution that contained 2.5 M active materials per 2.16 cm² of the carbon electrode material. The carbon electrode materials were subjected to the step of drying in vacuum ranging from 1×10² Pa to 1×10⁵ Pa, which is not more than the atmospheric pressure, for 30 minutes repeatedly twice. The carbon electrode materials were precipitated to coat at least a part of the surface of the carbon electrode material with the precipitations containing the active materials like a thin film. The carbon electrode materials carried the active materials.

### Example 2

Carbon electrode materials for the cathode and the anode were impregnated with 0.3 mL of a solution that contained 2.5 M active materials per 2.16 cm² of the carbon electrode material. The carbon electrode materials were subjected to the step of drying in vacuum ranging from 1×10² Pa to 1×10⁵ Pa or lower, which is not more than the atmospheric pressure, for 30 minutes repeatedly three times. The carbon electrode materials were precipitated to coat at least a part of the surface of the carbon electrode material with the precipitations containing the active materials like a thin film. The carbon electrode materials carried the active materials.

### Example 3

Carbon electrode materials for the cathode and the anode were impregnated with 0.3 mL of a solution that contained 2.5 M active materials per 2.16 cm² of the carbon electrode material. The carbon electrode materials were subjected to the step of drying in vacuum ranging from 1×10² Pa to 1×10⁵ Pa or lower, which is not more than the atmospheric pressure, for 30 minutes repeatedly four times. The carbon electrode materials were precipitated to coat at least a part of the surface of the carbon electrode material with the precipitations containing the active materials like a thin film. The carbon electrode materials carried the active materials.

### Comparative Example 1

Carbon electrode materials for the cathode and the anode were impregnated with 0.3 mL of a solution that contained 2.5 M active materials per 2.16 cm² of the carbon electrode material. The carbon electrode materials were subjected to the step of drying on a hot plate at 180° C. in the atmospheric pressure (approximately 1.01×10⁵ Pa) for ten minutes repeatedly twice. In the carbon electrode materials, precipitations containing the active materials were precipitated on at least a part of the surface of the carbon electrode material. The carbon electrode materials carried the active materials. The precipitations developed crystal growth in bulk on the surface of the carbon electrode material.

### Comparative Example 2

Carbon electrode materials for the cathode and the anode were impregnated with 0.3 mL of a solution that contained 2.5 M active materials per 2.16 cm² of the carbon electrode material. The carbon electrode materials were subjected to the step of drying on a hot plate at 180° C. in the atmospheric pressure for ten minutes repeatedly three times. In the carbon electrode materials, precipitations containing the active materials were precipitated on at least a part of the surface of the carbon electrode material. The carbon electrode materials carried the active materials. The precipitations developed crystal growth in bulk on the surface of the carbon electrode material.

### Comparative Example 3

Carbon electrode materials for the cathode and the anode were impregnated with 0.3 mL of a solution that contained 2.5 M active materials per 2.16 cm² of the carbon electrode material. The carbon electrode materials were subjected to the step of drying on a hot plate at 180° C. in the atmospheric pressure for ten minutes repeatedly four times. In the carbon electrode materials, precipitations containing the active materials were precipitated on at least a part of the surface of the carbon electrode material. The carbon electrode materials carried the active materials. The precipitations developed crystal growth in bulk on the surface of the carbon electrode material.

The amounts of the active materials carried by the carbon electrode material for the cathode and the carbon electrode material for the anode were measured as follows. The results are shown in Table 1. The carbon electrode material for the cathode and the carbon electrode material for the anode were processed to prepare a cathode current collector and an anode current collector, respectively. Between the cathode current collector and the anode current collector, a separator (polyethylene microporous film) of same size as the current collectors was disposed. For the extraction electrodes, graphite of same size as the current collectors was used. The extraction electrodes were disposed respectively outside of the cathode current collector and the anode current collector. One cell was manufactured by laminating the extraction electrode, the cathode current collector, the separator, the anode current collector, and the extraction electrode in this order. A cell stack was manufactured by inserting the one stack into a cell having the area of base of 2.16 cm² and the thickness of 3 mm. To the cell, 0.5 mL of 2 M sulfuric acid was added. Conductive carbon fiber was connected to the extraction electrodes in the cell. A part of the conductive carbon fiber projected from the cell. A VSSB including the one cell stack was manufactured.

The mass of active material, the theoretical capacity, and the effective utilization per 1 cm² of the electrodes of the vanadium solid-salt batteries in Examples 1 through 3 and Comparative Examples 1 through 3 were measured as follows. The results are shown in Table 1 and FIG. 10.

(Method of Measuring Mass of Active Material Per 1 cm² of Electrode)

The mass of active material (g/cm²) per 1 cm² of the electrodes carried by the cathode and the anode was calculated based on the formula (ii) below. Specifically, the mass of active material was obtained by dividing, by the area, a numerical value of a difference of subtracting the mass of carbon electrode materials before carrying the active materials from the mass of carbon electrode materials after carrying the active materials. The mass (g) of carbon electrode materials was measured with an electronic balance (trade name: XS105, manufactured by Mettler-Toledo International Inc.).

Mass of active material (g/cm²) per 1 cm² of electrode=(Mass (g) of carbon electrode material after carrying active material−Mass (g) of carbon electrode material before carrying active material)÷Area (cm²) of carbon electrode material (ii)

(Theoretical Capacity)

The theoretical capacity of the batteries in Examples and Comparative Examples was measured based on the formula (iii) below from the mass of active material carried by the cathode and the anode.

Theoretical capacity (Ah)=Amount of substance (mol) of vanadium×Faraday constant÷3600 (iii)

(In the formula, the amount of substance of vanadium is mass of active material per 1 cm² of electrode×area of carbon electrode material÷molecular weight of active material, and the Faraday constant is 96500 (C/mol).)

(Effective Utilization)

The respective vanadium solid-salt batteries of Examples and Comparative Examples were charged up to 1.6 V at current density of 5 mA/cm² and discharged down to the cut-off voltage of 0.7 V at current density of 5 mA/cm² to calculate the discharge capacity. For the charge and discharge device, PFX2021 (manufactured by Kikusui Electronics Corp.) was used. The effective utilization was calculated based on the formula (i) from the measured discharge capacity and the theoretical capacity. The results are shown in Table 1.

Effective utilization (%)=Discharge capacity/Theoretical capacity×100 (i)

TABLE 1

| | Cathode | Anode | | | |
|---|---|---|---|---|---|
| | Active | Active | | | |
| | Material | Material | Theoretical | Discharge | Effective |
| | Mass | Mass | Capacity | Capacity | Utilization |
| | (g/cm²) | (g/cm²) | (mAh/g) | (mAh/g) | (%) |
| Example 1 | 0.148 | 0.148 | 52.6 | 45.1 | 85.7 |
| Example 2 | 0.245 | 0.245 | 87.0 | 65.7 | 75.5 |
| Example 3 | 0.324 | 0.324 | 115 | 81.0 | 70.4 |
| Comparative | 0.148 | 0.148 | 52.6 | 42.1 | 80.0 |
| example 1 | | | | | |
| Comparative | 0.245 | 0.245 | 87.0 | 32.8 | 37.7 |
| example 2 | | | | | |
| Comparative | 0.324 | 0.324 | 115 | 16.2 | 14.1 |
| example 3 | | | | | |

FIG. 4 illustrates a photograph by a 200-power optical microscope of a carbon electrode material that carries the precipitations used for the anode of the VSSB in Example 3. FIG. 6 illustrates a photograph by a 200-power optical microscope of the carbon electrode material that carries the precipitations used for the anode of the VSSB in Comparative Example 3.

(Consideration on Results)

FIG. 10 is a graph illustrating relationship between the mass of active material (amount of carried active materials) in the cathode or the anode of the vanadium solid-salt batteries in Examples 1 through 3 and Comparative Examples 1 through 3 and the effective utilization of the respective vanadium solid-salt batteries. In the vanadium solid-salt batteries in Examples 1 through 3, at least a part of the surface of the carbon electrode material is coated with the precipitations like a thin film. As illustrated in FIG. 10, in the vanadium solid-salt batteries in Examples 1 through 3, it is possible to bring the electrical capacity of the VSSB closer to the theoretical capacity even when the amount of carried precipitations increases. The vanadium solid-salt batteries in Examples 1 through 3 are capable of having the effective utilization of the battery of 70% or greater. In contrast, in the vanadium solid-salt batteries in Comparative Examples 1 through 3, bulk precipitations are present in at least a part of the surface of the carbon electrode material. In the vanadium solid-salt batteries in Comparative Examples 1 through 3, the effective utilization of the battery decreased as the amount of carrying the precipitations that contain the active materials increased.

As illustrated in FIG. 4, in the carbon electrode material used for the VSSB in Example 3, at least a part of the carbon fiber was coated with the precipitations like a thin film.

In contrast, as illustrated in FIG. 6, in the carbon electrode material used for the VSSB in Comparative Example 3, bulk precipitations 12 were attached on the carbon fiber 11.

### INDUSTRIAL APPLICABILITY

The VSSB of the present disclosure is very useful in that both requirements of light weight and small size and high output performance are satisfied and it is possible to improve still higher capacity, that is, effective utilization. It is possible to use the VSSB of the present disclosure in the field of large power storage. The VSSB of the present disclosure may be widely used for personal computers, personal digital assistances (PDAs), digital cameras, digital media players, digital recorders, games, electrical appliances, vehicles, wireless devices, mobile phones, and the like.

1. A vanadium solid-salt battery comprising:
electrodes containing a carbon electrode material that carries a precipitation containing a vanadium ion or a vanadium-containing cation as an active material; and
a separator disposed between the electrodes, wherein
at least a part of a surface of the carbon electrode material is coated with the precipitation.

2. The vanadium solid-salt battery according to claim 1, wherein effective utilization is 70% or greater.

3. The vanadium solid-salt battery according to claim 1, wherein the carbon electrode material is carbon fiber or activated carbon.

4. The vanadium solid-salt battery according to claim 1, wherein
the battery includes:
an anode having at least a part of the surface of the carbon electrode material coated with a precipitation containing a vanadium ion having an oxidation number varied between divalence and trivalence by a reduction/oxidation reaction or a vanadium-containing cation having an oxidation number varied between divalence and trivalence by a reduction/oxidation reaction; and
a cathode having at least a part of the surface of the carbon electrode material coated with a precipitation containing a vanadium ion having an oxidation number varied between pentavalence and tetravalence by a reduction/oxidation reaction or a vanadium-containing cation having an oxidation number varied between pentavalence and tetravalence by a reduction/oxidation reaction.

5. The vanadium solid-salt battery according to claim 1, wherein the separator is a porous film, non-woven fabric, or an ion exchange membrane.

6. A method of manufacturing a vanadium solid-salt battery, comprising:
impregnating a carbon electrode material with a solution containing a vanadium ion or a vanadium-containing cation to be an active material; and
carrying a precipitation in the carbon electrode material by drying the carbon electrode material in vacuum to coat at least a part of a surface of the carbon electrode material with the precipitation containing the vanadium ion or the vanadium-containing cation to be the active material.
